(19) United States
(12) Patent Application Publication
(10) Pub. No.: US 2002/0119801 A1
(43) Pub. Date: Aug. 29, 2002

(54) Portable telephone apparatus

(76) Inventors: Yasushi Nemoto, Naka (JP); Takashi Tobita, Mito (JP); Chuuji Chigisaki, Naka (JP); Takashi Ishikawa, Hiratsuka (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/797,255

(22) Filed: Feb. 28, 2001

(51) Int. Cl. H04M 1/00

(52) U.S. Cl. 455/550; 455/90

(57) ABSTRACT

A portable telephone apparatus of folding type, having a upper side housing 1 and a lower side housing 2, and the first one being rotatable to second one through a hinge 91, wherein an antenna containing device 213 is provided in parallel beside the lower side body 2, and an antenna 3 is inserted into the antenna containing device 213 in a direction, crossing at a right angle with a line extending in an axial line of the hinge 91, and the antenna 3 is held by the antenna containing device 213, thereby enabling to attach the antenna onto the lower side housing but without increase in the thickness thereof.

### BACKGROUND OF THE INVENTION

1. Field of the Invention

The present invention relates to a portable telephone apparatus of a folding type, in which a first housing is rotationally movable to a second housing.

2. Description of Prior Art

For portable mobile units, including mainly a telephone apparatus therein, advance was made rapidly, in particular in small-sizing and high performances, with the advancement of electronic circuit technology. In recent years, such a telephone apparatus is required, that is equipped with a terminal function for the Internet, and then has a distinctive feature on a display, i.e., having a large screen. From this viewpoint, attention was paid to a portable telephone apparatus of a folding type, though it is a little bit larger in the thickness under the condition of being folded.

With such the folding type portable telephone apparatus, it can be considered that there are still problems, in particular, in a method for obtaining electrical and mechanical connecting between two (2) housings divided by a hinge portion, in the position of an antenna enabling easy handling, and in thinning in the thickness thereof.

Among of them, in relation with the electrical and mechanical connection, a method is disclosed in Japanese Patent No. 2821333, in which a flat cable (FPC) for obtaining electrical connection between circuit boards within two (2) housings is rotated in a helical manner by means of a hinge portion. Also, relating to the position of the antenna, the abovementioned Japanese Patent No. 2821333 discloses a technology, in which the antenna is disposed on an upper housing equipped with the display portion, between the two (2) housings. On the contrary to this, Japanese Patent No. 2582531 discloses a technology, in which the antenna is disposed on a housing of a lower side, being equipped with the key switches thereon.

Normally, the antenna applied for use in the portable telephone apparatus is in a form that a helical antenna is connected at a tip of a whip antenna on a straight line. Those antennas have the highest sensitivity in the radial direction within a cylindrical space around an axis thereof, and each has an effective portion as the antenna from the tip thereof to a low electric potential portion, which is connected to the circuit board. The portion of the antenna, which is connected to the earth, is inserted in a pipe-like portion for use of holding the antenna therein, which is connected to an input terminal of an amplifier on the circuit board, so as to be held at the position thereof.

The length of this portion is required to be in a predetermined ratio with respect to the wavelength of the radio wave to be used. In the portable telephone apparatus of folding type, the size in direction of length is short in the housing, therefore it is a problem to find a manner to keep the antenna long.

Here, comparison is made on an installation of an antenna in the folding type portable telephone apparatus. As shown in FIG. 11, when a receiver (a speaker) provided on the upper side housing touches on an ear, a sender (a microphone) on the lower side housing must be located near to a mouth, therefore the angle defined by the upper side housing and the lower housing must be set to 160 degree, more or less. Then, in an attachment of the antenna on the portable telephone, it is possible to make the distance of the antenna, in particular, from a tip of the helical antenna to a head or a face, longer when the antenna is attached on the lower side housing as shown in the FIG. 11(a), than when it is attached on the upper side housing as shown in the FIG. 11(b), (da>db). With this, it is possible to protect a user from being disturbed by the antenna when she/he wears a hat or wears a wig larger than the head, or has a hair style larger than the head.

Also, if the antenna is attached on the upper side housing, on which the display device is disposed, since a high-frequency amplifier circuit is preferably located at a position near to the antenna, they are disposed on the same upper side housing. On the other hand, it is common to locate a base-band processor circuit within the lower side housing, in which also key switches and a battery are disposed, therefore as a result, signal having a very high frequency pass through the helical flat cable, then the consideration must be made for suppressing a loss of the high frequency signal in the helical portion.

Contrary to this, if the antenna is disposed on the lower side housing, also the high frequency signal amplifier is disposed in the lower side housing, then the main circuits can be entered into the lower side housing, therefore it becomes easy to take a measure upon the loss of the high frequency signals. Also, in the lower side housing, there is no factor to be enlarged in size in the width direction thereof, and also even from a viewpoint of handiness, the size in the vertical direction thereof can be made smaller than when the antenna is attached on the upper side housing.

However, in the portable telephone apparatus, in which the antenna is disposed on the lower side housing equipped with the key switches thereon, between the two (2) housings, when the direction of attachment of the antenna conflicts the direction of insertion of the hinge, the attachment of the antenna or the insertion of the hinge cannot be practiced, therefore, in the Japanese Patent No. 2582531, there are made devices; such as, the lower side housing is made thicker in the thickness in the vertical direction, and the hinge portion is disposed in an upper portion of that thickness while the antenna in a lower portion thereof, etc. However, in this instance, since the lower side housing is increased in the thickness thereof, it brings about an an inconvenience, in particular, when it is put into or taken out from a briefcase or a bag.

### SUMMARY OF THE INVENTION

Therefore, an object, according to the present invention, is to provide a folding type portable telephone apparatus, in which an upper side housing is rotationally movable with respect to a lower side housing, being thin in the thickness and easy in assembling thereof.

According to the present invention, for accomplishing the above-mentioned object, there is provided a portable telephone apparatus, comprising: a first housing; a second housing, being connected to said first housing through a hinge, to be freely folded; an antenna containing device provided on a side of said second housing in parallel; and an antenna held in said antenna containing device, to be freely movable, in a direction crossing over a line extended in a direction of an rotary axis of said hinge, wherein: said hinge is disposed at an end portion of said second housing, facing onto said first housing, and extending along a movable direction of said antenna, and has a pin functioning as an axis of rotary movement of said housings; said antenna containing device extends to an end portion of said second housing on a side facing onto said first housing; and an antenna holder member is detachably attached at an end portion of said antenna containing device, in a position so that it overlaps over at least a part of a portion obtained by projecting said pin in the axial direction thereof, whereby said antenna is movably held by said antenna containing portion and said antenna holder member.

Further, according to the present invention, there is provided the portable telephone apparatus, as defined in the above, wherein said antenna has a whip antenna and a helical antenna connected to the whip antenna, said antenna holder member has an electric connection portion being connectable to said antenna therein, wherein said helical antenna is electrically connected to said electric connection portion when said antenna is received therein, while said whip antenna is electrically connected to said electric connection portion when said antenna is pulled out therefrom.

Further, according to the present invention, there is also provided the portable telephone apparatus, as defined in the above, wherein said antenna containing device has a first pipe, said antenna has a helical antenna connected to a whip antenna, an electrically non-conductive antenna holder member for fixing said helical antenna, and a second pipe fixed to said antenna holder member, wherein insertion of said whip antenna into said antenna containing device and connection of said second pipe to said first pipe bring said antenna holder member to be located beside said hinge, thereby said antenna is held by said antenna containing device.

And also, according to the present invention, there is further provided the portable telephone apparatus, as defined in the above, wherein gutters are formed on opposing portions of said first pipe and said second pipe, and engagement between said gutters bring said antenna to be held by said antenna holder device.

### BRIEF DESCRIPTION OF THE DRAWINGS

FIG. 1 is a perspective view for showing the structure of the portable telephone apparatus, according to a first embodiment of the present invention;

FIG. 2 is a plan view for showing the structure of the portable telephone apparatus, according to the first embodiment of the present invention;

FIG. 3 is a front view for showing the structure of the portable telephone apparatus, according to a first embodiment of the present invention;

FIG. 4 is an exploded side view for showing a hinge portion of the portable telephone apparatus, according to the first embodiment of the present invention;

FIG. 5 is a plan view for showing a rear case of the portable telephone apparatus, under the condition of being removed with a front case thereof, according to the first embodiment of the present invention;

FIG. 6 is a front view for showing the rear case of the portable telephone apparatus, according to the first embodiment of the present invention;

FIG. 7 is a front view for showing a front case of the lower side housing in the portable telephone apparatus, according to the first embodiment of the present invention;

FIG. 8 is a cross-section view of a principle portion of an antenna and an antenna containing device in the portable telephone apparatus, according to the first embodiment of the present invention;

FIGS. 9(a) to 9(d) are views for explaining about assembling of the antenna and the antenna containing device in the portable telephone apparatus, according to the first embodiment of the present invention, and in particular,

FIG. 9(a) shows a front view for showing a principle portion of the antenna;

FIG. 9(b) a front cross-section view for showing the principle portions of an antenna holding case and the antenna containing device; and

FIG. 9(c) a front cross-section view for showing a condition of installing the antenna holding case onto the antenna containing device; and

FIG. 9(d) a front cross-section view for showing a condition of installing the antenna onto the antenna containing device, respectively;

FIG. 10 is a front view of the portable telephone apparatus, under a condition of pulling out the antenna 3 therefrom, according to the first embodiment of the present invention; and

FIGS. 11(a) and 11(b) are views for explaining about a positional relationship between the antenna and a head in the folding type portable telephone apparatus, depending upon an installing position of the antenna: and in particular,

FIG. 11(a) shows a view when the antenna is attached on the lower side housing; and

FIG. 11(b) a view when the antenna is attached on the upper side housing, respectively.

### DESCRIPTION OF PREFERRED EMBODIMENTS

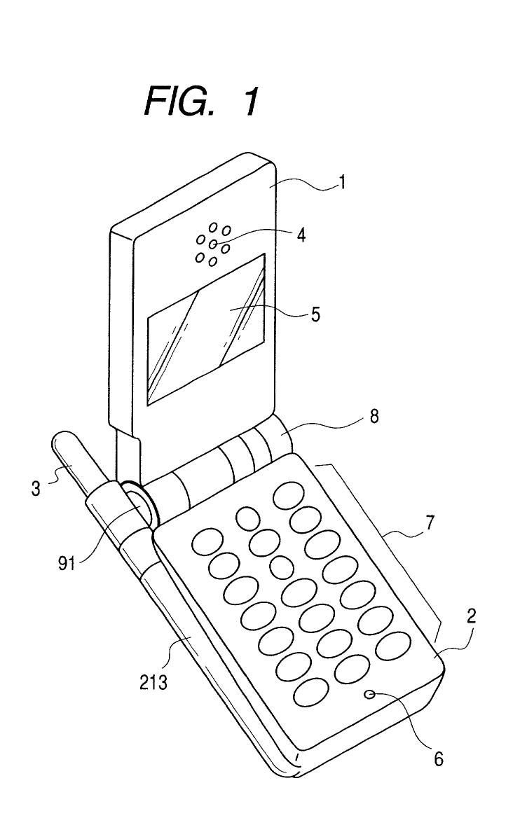

Hereinafter, embodiments according to the present invention will be fully explained by referring to the attached FIGS. 1 to 10.

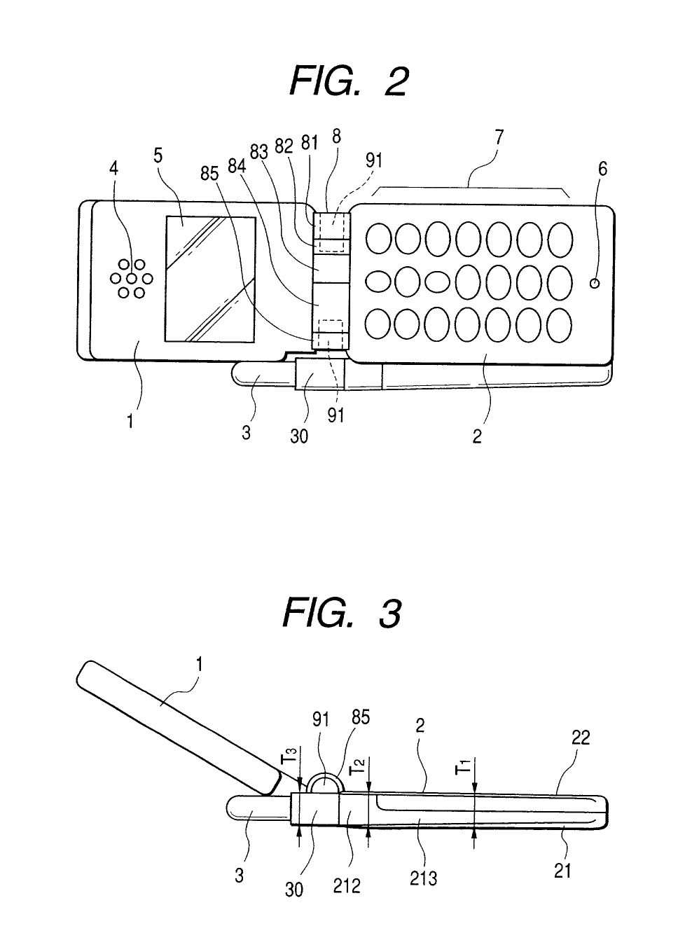

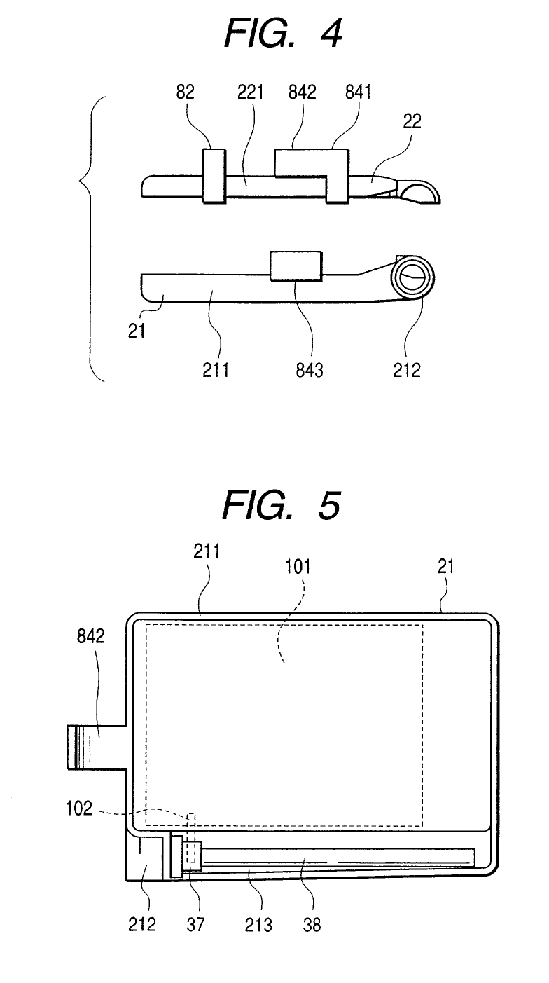

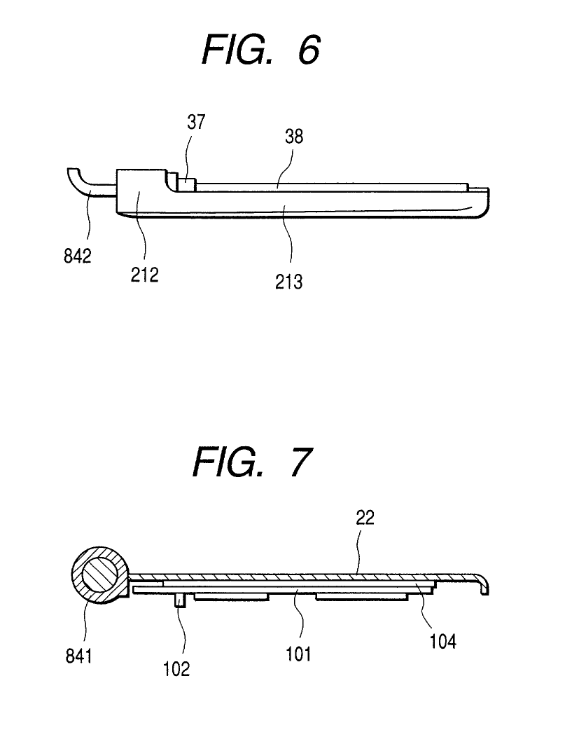

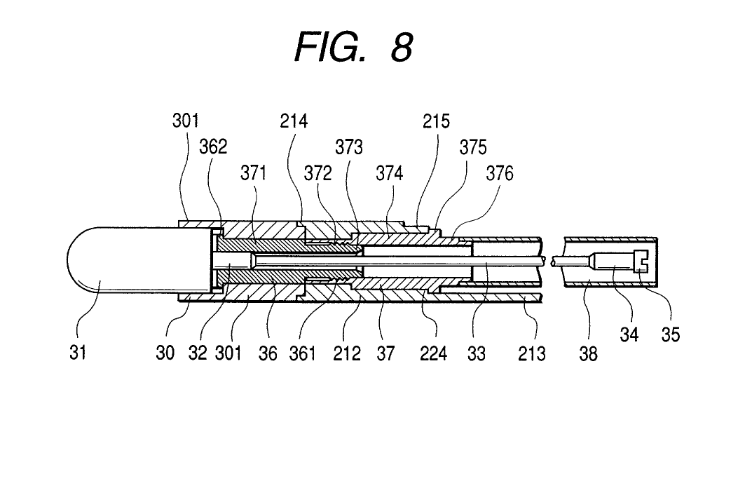

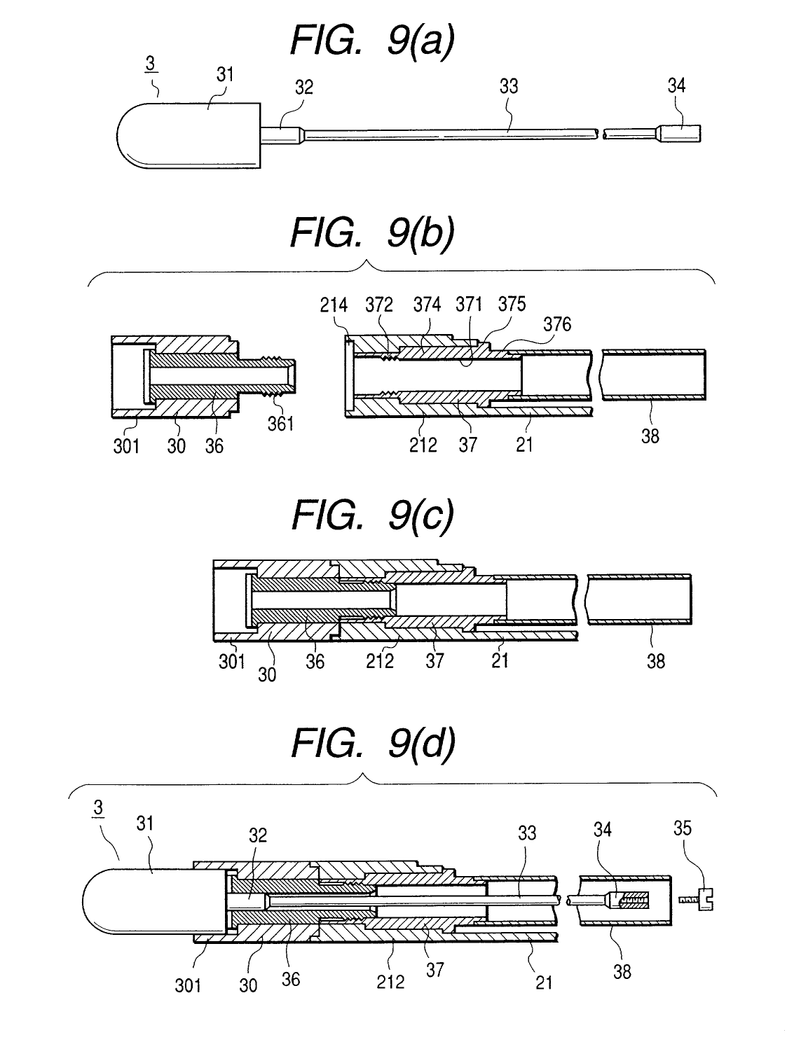

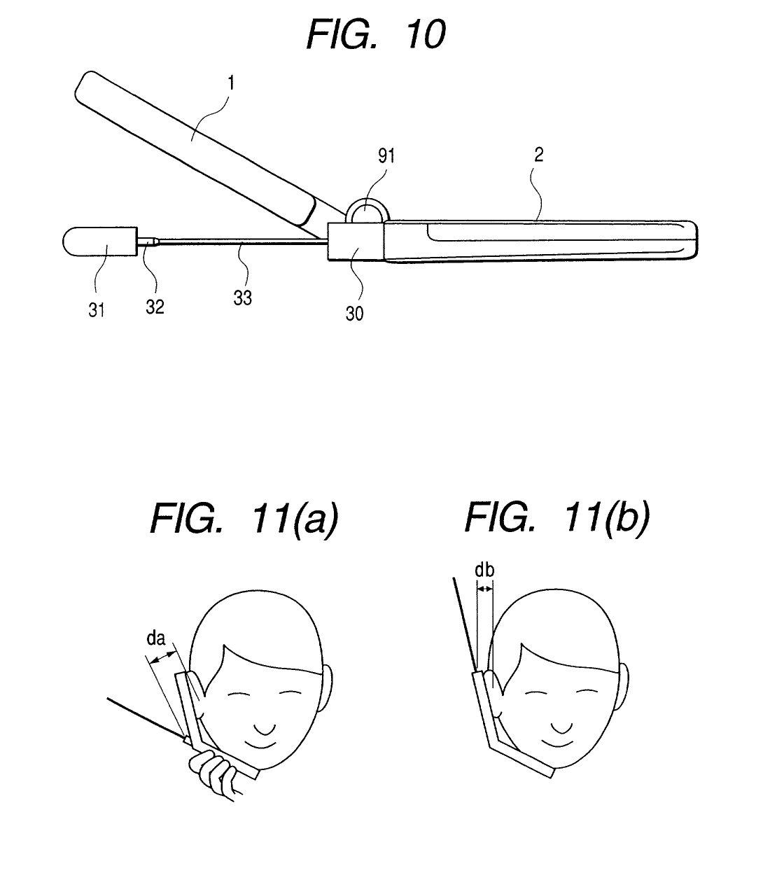

FIG. 1 is a perspective view for showing an outline of an embodiment according to the present invention. FIG. 2 is a plan view of the embodiment shown in the FIG. 1. FIG. 3 is a side view of seeing the embodiment shown in the FIG. 2 from a front thereof. FIG. 4 is an exploded view of a hinge portion before assembling thereof, seeing from the left-hand side to the right-hand side in the FIG. 3. FIG. 5 is a view of a rear case, seeing from above and removing a front case of the lower side housing therefrom, in the FIG. 3. FIG. 6 is a side view, seeing from a front in the FIG. 5. FIG. 7 is a view of showing a cross-section of the lower side housing of the FIG. 2 on a front case side thereof. FIG. 8 is a cross-section partial view of an antenna and an antenna holding device of the lower side housing, shown in the FIG. 2. FIG. 9 a cross-section partial view for explaining assembling of those shown in the FIG. 8. FIG. 10 is a side view of that shown in the FIG. 3 with pulling out the antenna therefrom.

As shown in FIG. 1, an upper side housing 1, as a first housing, is attached to a lower side housing 2, as a second housing, rotatably at hinge portion 8. Openings of a receiver are formed in an upper portion of the upper side housing 1, on a front surface thereof, and inside the openings is disposed a receiver 4 (a speaker). In almost central portion of the upper side housing 1 on the front surface thereof, a liquid crystal display portion 5 is disposed. On a front surface of a lower side housing are disposed plural number of key switches 7. Those key switches 7 are used for inputting a telephone number when a user makes a telephone call, or for inputting letters or characters for preparing sentences of a mail. An opening for use of sender is provided in a lower portion of the lower side housing 2 on the front surface thereof, and inside the opening, a sender 6 (a microphone) is disposed.

As shown in FIGS. 2 and 3, at an end portion of the upper side housing 1, facing onto the lower side housing 2, there are provided cylindrical portions 81 and 85 for use in insertion of pins 91 and a flat cable receiving portion 83, on the other hand, at an end portion of the lower side housing 2, facing onto the upper side housing 1, there are provided cylindrical portions 82 and 84 for use in insertion of the pins 91. The cylindrical portions 82 and 84 are projected in the direction, in which the antenna is extended at the end portion facing onto the housing 1 under the condition that the housings 1 and 2 are opened. Herein, the lower side housing 2 is formed with a front case 22 and a rear case 21, and the cylindrical portion 84 is formed with a cylindrical portions 841 and 842, and further has a space defined by butting the shapes, which are provided on both side of the front case 22 and the rear case 21 constructing the lower side housing 2, and each of which has a projection of a flat plate attached with a quarter (¼) circle at the tip thereof.

Insertion of the pins 91 into the cylindrical portions 84 and 85 from sides opposing to each other, the cylindrical portions 81, 82, 83, 84 and 85 form a hinge portion, thereby connecting the upper side housing 1 and the lower side housing 2 to each other, rotatably. The upper side housing 1 and the lower side housing 2 can be fold, so that the upper side housing 1 and the lower side housing 2 contact with each other on the front surfaces thereof, and a stopper (not shown in the figure) is provided in the hinge portion, so that an angle defined by them when they are extended or opened does not exceed over about 160 degree. With that, it is prevented that the upper side housing 1 comes in contacts with the antenna 3 thereby giving damage onto the antenna 3.

The lower side housing is made up with a front case 22 and a rear case 21, and inside the lower side housing 2 are stored key switches 104, at a central portion thereof as shown in FIG. 7, and a circuit board 101, being laminated on the side of the front case 22. Into a battery receiving portion 211 of the rear case 21, a battery not shown in the figure is stored. As shown in FIG. 5, beside the rear case 21 is provided an antenna containing device which is made up with an antenna attaching portion 212 and an antenna containing portion 213, and this antenna containing device contains an antenna 3 to be held therewith. Details of the antenna containing device will be explained later.

To the circuit board 101 is connected the flat cable not shown in the figure, for electrically connecting to the liquid crystal portion 5 and the receiver 4, which are stored within the upper side housing 1. As shown in the FIG. 5, in the portion just near to an antenna contact pipe 37 of the circuit board 101, a spring 102 is fixed for electrically connecting between the antenna 3 and the circuit board 101. The front case 22 and the rear case 21 are engaged with the respective walls, which are provided on an outer periphery of a circuit board receiving portion and the battery receiving portion, and at the same time, the front case 22 is connected onto bosses which are provided in the rear case 21, by means of four (4) pieces of screws not shown in the figure, being disposed in the vicinity of both side corners on a side of the hinge, while putting the key switches 104 and the circuit board 101 therebetween. The lower side housing 2, after the connection of the front case 22 and the rear case 21, has a thickness of T₁. as shown in the FIG. 3.

In the rear case 21 of the lower side housing 2, there are disposed an antenna attachment portion 121 and the antenna containing portion 213 in parallel beside the battery receiving portion 211, and the outer periphery of this battery receiving portion 211 is engaged with a corresponding portion of the front case 221, thereby constructing the structure for inhibiting the housing from being deformed. On an outside of the antenna attachment portion 212 and the antenna containing portion 213 are also provide walls similar to those mentioned above, however since the portion of the antenna attachment portion 212 is not divided in the direction of thickness, it is impossible to construct an continuous wall therewith, therefore the stiffness thereof is low, comparing to the outer periphery of the battery receiving portion 211. Therefore, an effect of suppressing the deformation of the housing is carried out by the wall of the battery receiving portion, mainly. Also, as shown in the FIG. 3, the antenna containing device, being made up with the antenna attachment portion 212 and the antenna containing portion 213, has the thickness T₂, and this thickness T₂ is set to be (T₂≦T₁) in all the portions thereof, with respect to the thickness T₁ of the lower side housing 2.

Explanation will be given on the antenna containing device, by referring to FIGS. 8 and 9. The antenna 3 is held by the rear case 21 of the lower side housing 2. Details of the antenna and the antenna holding device are shown in the FIG. 8. Herein, the antenna contact pipe 37 and a fastener pipe 36 are called by an antenna holder portion, collectively. The antenna 3 is constructed with a helical antenna portion 31, a helical contact portion 32, a whip antenna 33, a whip contact portion 34 and a screw 35. The helical antenna portion 31 and the whip antenna 33 and the respective contact portions 32 and 34 are electrically connected within an inside of the antenna.

A tip 214 of the antenna attachment portion 212 has a shape of doubled cylinder, and it is engaged or fit with a rear end of the corresponding doubled cylinder shape of the antenna holder case 30 as an antenna holder member, thereby being connected in the structure which will be mentioned later. A tip 301 of the antenna holder case 30 has also a shape similar to the doubled cylinder, and the inner diameter of an outer cylinder thereof is a little bit larger than the outer diameter of the helical antenna. Therefore, it is able to receive a base portion of the helical antenna 31 therein, and it restricts the deformation of the helical antenna 31 if a force is applied onto the helical antenna 31 in the horizontal direction when receiving the helical antenna 31 therein, thereby preventing an excessive force to be applied onto the helical contact portion 32 and the antenna 3 from giving damages thereon. Regarding a diameter T₃ of the antenna holder case 30, it is so set to be (T₃≦T₁). Also, in the present embodiment, it is set to be T₃=T₂, thereby preventing a step-like portion from being formed in the connecting portion between the antenna containing device.

The antenna contact portion 37 and the fastener pipe 36 pass through the bores of the antenna attachment portion 212 and the antenna holder case 30. An internal diameter of a contact cylinder portion 371 of the antenna contact portion 37 is a very little bit larger than an outer shapes of the helical contact portion 32 and the whip contact portion 34, therefore it is possible to shift the antenna 3 in the axial direction thereof, for putting into and pulling out therefrom, and at the same time, to generate friction, so as to hold the antenna 3 at that position with stability, as well as, obtaining electrical connection thereof with resistance being sufficiently low.

At one end of the fastener pipe 36 is formed a circular flange, in which a gutter or groove is provided for use of a “−” (minus) screwdriver, while on an interior surface of the other end thereof, a screw 361 is formed. The antenna contact pipe 37 has such the structure that it is connected to one end of a body 374, and a screw 372 is formed in an inner periphery on a side of the antenna contact portion 371. In an inner side of the body 374, a bore is provided for inserting a fixing screw 35 of the antenna with non-contact, and a deep side of that bore forms a wall portion 373 for preventing the move of the fixing screw 35.

In this manner, entering of the whip contact portion 34 into the body 374, to be contact with the antenna contact portion 371, prevents the portion of the antenna contact portion 371 of the whip antenna from becoming short, thereby enabling to lessen the factor of reducing the sensitivity as the antenna. Also, a flange 375 is formed on the other side of the body 374, and further the other side is formed in a cylindrical portion 376, and furthermore the tip of it is made to be small in the outer shape, so that a protection pipe 38 is inserted therein. The flange 375 has a polygonal shape not shown in the figure, and it is engaged with a rotation preventing mechanism, which is provided on the antenna attachment portion 212 but not shown in the figure, thereby preventing it from rotating when being assembled, as will be explained later.

In the FIGS. 2, 3 and 8, there is shown a condition where the antenna 3 is pulled back to a side of the lower side housing 2 with respect to the antenna holder portion. The antenna 3 is held in the antenna containing device, to be freely movable in a direction crossing over the line, being extended in the axial direction of the hinge 91, therefore it can be shifted from the condition the antenna 3 is pulled back, as shown in the FIG. 2, into the condition that it is pulled out, as shown in the FIG. 10, and vice versa. In this case, all of the helical antenna 31 is located on an opposite side to the upper side housing 2 with respect to the hinges 91, however almost all of the whip antenna 33 lies on a side of the lower side housing 2 with respect to the hinges 91, therefore more than a half of the antenna 3 as a whole lies on the side of the lower side housing 2. On a while, a view of the antenna 3 is shown in FIG. 10, seen from a side thereof under the condition where it is pulled out. In this case, all of the helical antenna 31 and a large part of the whip antenna 33 are located on the opposite side of the lower side housing 2 with respect to the hinges 91. However, in the present embodiment, the antenna 3 is freely movable in the direction crossing over the axial direction of the hinges 91 at the right angle.

Next, steps of assembling the antenna 3 and the antenna holder portion will be explained by referring to FIG. 9. As a whole of the apparatus, the assembling is performed in the following steps:

(1) Positioning the upper side housing and the lower side housing, while directing the front covers thereof downward, and inserting the hinges 91 from the both sides thereof, thereby completing the assembling of the hinge portion;

(2) Positioning assembled parts on the front cases of the upper side housing and the lower side housing, sequentially, and performing necessary operations thereon. In the lower side housing, a key switch sheet is positioned on the front case, and then the circuit board is positioned thereon. Also, the sender (the microphone) is disposed at a predetermined position;

(3) Inserting connector terminals of the flat cable for connecting the upper side housing and the lower side housing into a connector of the circuit board-like shape, in accordance with a predetermined operation steps;

(4) Installing the antenna 3 to the rear case of the lower side housing. Details of this will be explained in the following;

(5) Covering the rear cases of the upper side housing and the lower side housing on the front cases, respectively, and fitting a convex portion into a concave portion, each of which is formed on an outer peripheral wall of the case respectively, through a spring action. After that, the front case and the rear case of respective the upper side housing and the lower side housing are connected through the screws; and

(6) Installing the battery into the lower side housing.

Next, the details of the above step (4) will be explained by referring to the FIGS. 9(a) to 9(d), hereinafter. As shown in the FIG. 9(a), the antenna 3 is assembled under the condition of no fixing screw 35 shown in the FIG. 9(c), so as to be prepared in advance. As shown in the FIG. 9(b), the antenna holder case 30 and the festinating pipe 36, the antenna contact pipe 37, the protection pipe 38 and the rear case 21 are prepared, as a single part or element, respectively.

First, into the antenna attachment portion 212 of the rear case 21, the antenna contact pipe 37 is inserted, and next, the protection pipe 38 is inserted into the cylindrical portion 376 of the antenna contact pipe 37. Next, as shown in the FIG. 9(c) under the condition of being inserted into the antenna holder case 30, the fastner pipe 36 is engaged or fit with the antenna contact portion 371 of the antenna contact pipe 37, and thereafter the antenna holder case 30 is engaged or fit with the antenna attachment portion 212, and are fastened by rotating the fastener pipe 36 by a screwdriver. In this instance, an adhesive for use as rotation stopper is applied, in an appropriate amount thereof, onto the engaged or fitting portion between the antenna holder case 30 and the antenna attachment portion 212, and the screw portions of the fastener pipe and the antenna contact portion. Next, the antenna shown in the FIG. 9(a) is inserted into the bore or opening of the antenna contact portion 371 from a side of the whip contact portion 34, and pushed up to the dead end thereof. Under such the condition, as shown in the FIG. 9(c), the fixing screw 35 is screwed into the screw hole provided on an end surface of the whip contact portion 34, from an end portion of the protection pipe 38, and is fastened. In this instance, the screwing is conducted by applying an appropriate amount of the adhesive for use as rotation stopper.

With the structure and the assembling steps explained in the above, it is impossible to achieve the folding portable telephone apparatus, which is thin in the type and can be assembled easily, without obstacles onto antenna characteristics thereof.

Further, in place of the structure mentioned above, when a contact portion to the antenna is provided on the side of the fastener pipe 36, this is screwed up to be connected to the antenna attachment portion 212 attached with the antenna contact pipe 37 (it is called so, thought it comes off in contact with the antenna), together with the antenna holder case 30, under the condition that the antenna is inserted into the fastener pipe 36 in advance. In this case, there is a necessity of a tool to rotate the screw portion escaping from the antenna portion, when screwing it up. Herein, for bringing the positions, where the helical contact portion 32 and the whip contact portion 34 provided in the antenna 3 come in contact with the contact portion provided in the fastener pipe 36, to be near to each other, it is necessary to make the inner diameter of the bore of the contact portion, on the side of the second housing, larger than the butting portion for determining the pull-out position of the antenna, which also functions as the fixing screw in common, therefore the outer screws and the inner screws are exchanged to each other from the condition shown in the FIG. 8.

Under the condition where the antenna holder case 30 is installed into the antenna containing device, as shown in the FIGS. 3 and 10, it comes to be in the position, which overlaps with a portion of the projection (about a half in the FIGS. 3 and 10), obtained by projecting the pins 91 of the hinge portion in the axial direction thereof. In this condition, however since the attachment and/or detachment of the pins 91 is impossible, they are attached and/or detached under the condition that the antenna holder case 30 is removed, for example, when assembling the apparatus, or when disassembling, such as for repairing thereof.

Also, with the antenna holder case 30, if the size of the apparatus is short in the direction of length thereof, it is possible to elongate the length of the antenna by the length of the antenna holder case 30 in the axial direction thereof, thereby enabling to keep the length necessary for the antenna, so as to maintain good communication performances.

As was fully explained in the above, according to the present invention, it is possible to provide the portable telephone apparatus of folding type, in which the first housing is rotatable to the second housing through the hinge, as well as, is thin in the thickness and can be assembled with ease.

What is claimed is:

1. A portable telephone apparatus, comprising:
a first housing;
a second housing, being connected to said first housing through a hinge, to be freely folded;
an antenna containing device provided on a side of said second housing in parallel; and
an antenna held in said antenna containing device, to be freely movable, in a direction crossing over a line extended in a direction of an rotary axis of said hinge, wherein:
said hinge has a pin, being disposed at an end portion of said second housing, facing onto said first housing, and extending along a movable direction of said antenna, and functioning as an axis of rotary movement of said housings; said antenna containing device extends to an end portion of said second housing on a side facing onto said first housing; and an antenna holder member is detachably attached at an end portion of said antenna containing device, in a position so that it overlaps over at least a part of a portion obtained by projecting said pin in the axial direction thereof, whereby said antenna is held by said antenna containing portion and said antenna holder member, being freely movable.

2. A portable telephone apparatus, as defined in the claim 1, wherein said pin comes to be detachable under condition where said antenna holder member is removed from the end portion of said antenna containing device.

3. A portable telephone apparatus, as defined in the claim 2, wherein thickness of said antenna containing device is equal to or less than that of said second housing.

4. A portable telephone apparatus, as defined in the claim 1, wherein said antenna has a whip antenna and a helical antenna connected to the whip antenna, said antenna holder member has an electric connection portion being connectable to said antenna therein, wherein said helical antenna is electrically connected to said electric connection portion when said antenna is received therein, while said whip antenna is electrically connected to said electric connection portion when said antenna is pulled out therefrom.

5. A portable telephone apparatus of folding type, having a first housing and a second housing, and said first housing being rotatable to said second housing through a hinge, and further comprising:
an antenna containing device disposed in parallel, on a side of said second housing; and
an antenna, being held in said antenna containing device, to be freely movable in a direction, directing to cross at a right angle with a line extending in an axial direction of said hinge, wherein thickness of said antenna containing device is equal to or less than that of said second housing.

6. A portable telephone apparatus, as defined in the claim 5, wherein said antenna has a helical antenna connected to a whip antenna, and an electrically non-conductive antenna holder member for fixing said helical antenna, wherein said antenna holder member is located beside said hinge, when said antenna is inserted into said antenna receiver device, thereby said antenna is held by said antenna containing deice.

7. A portable telephone apparatus, as defined in the claim 5, wherein said antenna containing device has a first pipe, said antenna has a helical antenna connected to a whip antenna, an electrically non-conductive antenna holder member for fixing said helical antenna, and a second pipe fixed to said antenna holder member, wherein insertion of said whip antenna into said antenna containing device and connection of said second pipe to said first pipe bring said antenna holder member to be located beside said hinge, thereby said antenna is held by said antenna containing device.

8. A portable telephone apparatus, as defined in the claim 7, wherein gutters are formed on opposing portions of said first pipe and said second pipe, and engagement between said gutters bring said antenna to be held by said antenna holder device.
